(19) United States
(12) Patent Application Publication
(10) Pub. No.: US 2004/0023752 A1
(43) Pub. Date: Feb. 5, 2004

(54) Pressure vessel for a continuously variable transmission pulley

(76) Inventors: Jeffrey L. Lubben, Pinckney, MI (US); Russell David Abrams, Saline, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 10/211,870

(22) Filed: Aug. 2, 2002

(51) Int. Cl. F16H 15/04; F16H 63/00

(52) U.S. Cl. 476/18

(57) ABSTRACT

A pressure vessel for a variable sheave pulley includes a tubular portion which is fitted to a cylindrical extension on the sheave. A groove within the cylindrical extension retains an O-ring seal, which is compressed by the tubular portion during assembly and retained in that compressed state during operation. The tubular portion has an end which is crimped into an annular groove formed between the cylindrical portion of the pulley and an inner wall or radial wall of the pulley. The O-ring seal is unaffected by the crimping operation or by pulley deflection, which occurs during power transmission.

### TECHNICAL FIELD

This invention relates to continuously variable transmissions and, more particularly, to the pressure vessel portion of at least one of the pulleys within the continuously variable transmission.

### BACKGROUND OF THE INVENTION

A continuously variable transmission (CVT) of the belt and pulley type has at least one sheave or pulley half that is adjusted by pressure. The pressure actuating the sheave half is contained within a pressure vessel that is mounted on the pulley. The pressure vessel has at least one sealing point that is part of the movable sheave of the variable pulley. This joint must be sealed to prevent leakage of fluid from the pressure vessel, which would impair the operation of the continuously variable transmission.

The pulley seal joint is susceptible to deflection of the pulley due to the belt clamping forces that are found between the sheave halves. The seal structure must withstand this pulley deflection or sheave half deflection in order to operate consistently and reliably.

### SUMMARY OF THE INVENTION

It is an object of the present invention to provide an improved pressure vessel for a pulley in a continuously variable transmission.

In one aspect of the present invention, the pressure vessel has a cylindrical wall which has an end portion crimped into and retained within an annular groove formed on a pulley half.

In another aspect of the present invention, the pulley half has a cylindrical wall adjacent the cylindrical recess in which a seal ring is disposed.

In yet a further aspect of the present invention, the cylindrical wall of the pressure vessel is in sealing contact with the O-ring disposed in the cylindrical groove of the pulley half.

In yet still another aspect of the present invention, the crimped portion of the pressure vessel cylinder is separated from the sealing portion of the pressure vessel cylindrical portion thereby eliminating the effect of pulley deflection during pressurization of the pressure vessel.

In yet still a further aspect of the present invention, the O-ring seal is not susceptible to damage during assembly of the pressure vessel, or during the crimping process or the crimping shape for pulley deflection.

### DESCRIPTION OF THE DRAWINGS

FIG. 1 is a cross-sectional view of a variable diameter pulley used in a continuously variable transmission (CVT).

FIG. 2 is an enlarged view of the circled portion “A” of FIG. 1.

### DESCRIPTION OF AN EXEMPLARY EMBODIMENT

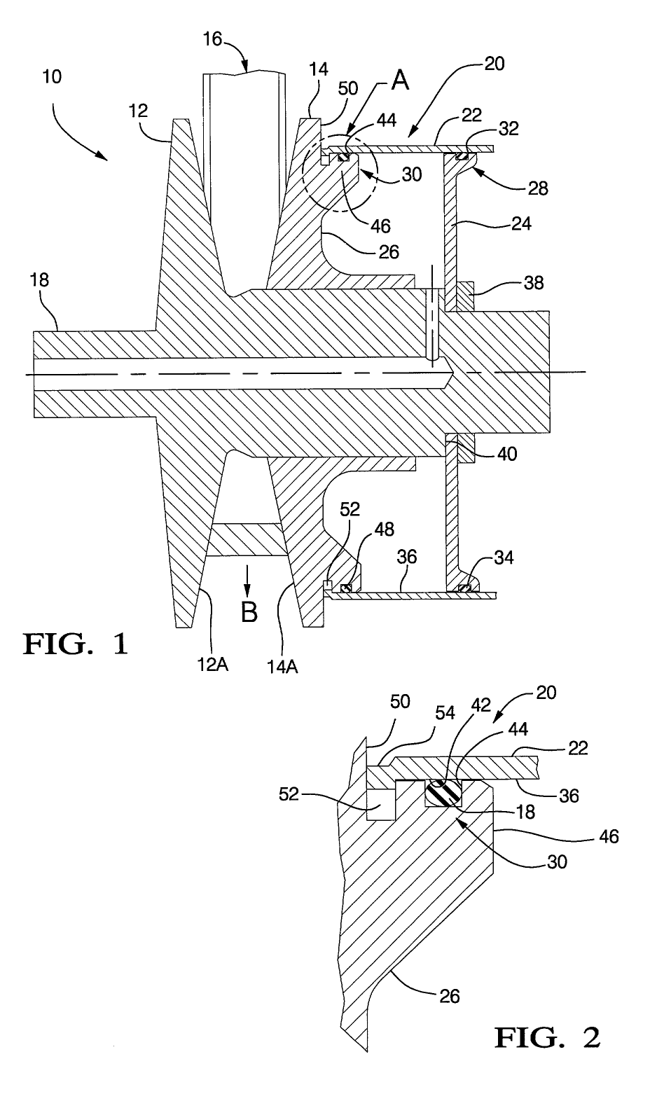

Referring to the drawings, there is seen in FIG. 1 a variable diameter pulley or sheave 10, which is a portion of a conventional continuously variable transmission (CVT), not shown. The operation and components of a CVT are well known to those skilled in the art.

The pulley 10 includes a fixed sheave half 12 and a movable sheave half 14. The sheave halves 12 and 14 have respective drive faces 12A and 14A. A drive belt 16 is housed between the sheave halves 12 and 14 in frictional engagement with the drive faces 12A and 14A. Sheave half 12 is integral with or otherwise secured to a shaft 18 that provides driven power or rotating power from the pulley 10 to portions of the CVT. The sheave half 14 is slidable along the shaft 18 of the pulley half 12 to affect the positioning of the belt 16 between the pulley halves 12 and 14.

As the pulley half 14 moves toward the pulley half 12, the belt 16 will be forced in the direction of Arrow B, thereby increasing the diameter that operates within the pulley 10. The pulley 10 is preferably the driven pulley of the belt portion of the CVT, such that as the belt 16 moves along the drive faces 12A and 14A in the direction of the Arrow B, the ratio between the input pulley, not shown, and the output pulley 10 is reduced, thereby moving toward an underdrive ratio within the CVT.

The pulley half 14 has associated therewith a pressure vessel generally designated 20. The pressure vessel 20 includes a cylindrical portion 22, a radial wall 24, and a radial wall 26 formed on the pulley half 14. The pressure vessel 20 has two sealing junctions or joints 28 and 30. The sealing junction 28 includes an annular groove 32 formed in the radial wall 24 and an annular O-ring or sealing ring 34 which is positioned in the groove 32 and compressed therein by an inner surface 36 of the cylindrical portion 22. The radial wall 24 is secured on the shaft 18 by a retaining ring 38 that maintains the shaft in position between the retaining ring 38 and a wall or step 40 formed on the shaft 18. Other structures to maintain the radial wall 24 in its position are well known and can be utilized.

The sealing joint 30 includes a portion 42 of the inner wall 36, an annular groove 44 formed in a cylindrical extension 46 of the pulley half 14, and an O-ring or sealing ring 48 disposed within the groove 44. The cylindrical extension 46 and a radial face 50 of the pulley 14 cooperate to form an annular groove or recess 52.

The cylindrical portion 22 has a crimped end 54 that is displaced into the cylindrical groove 52 during assembly of the pressure vessel 20 through the pulley half 14. The cylindrical portion 22 is a tubular metal component that has a machined inner surface 36, which provides a good sealing surface in combination with the O-ring 48. During assembly, the inner surface 36 of the cylindrical portion 22 compresses the O-ring 48 a desired or appropriate amount to provide sealing of the pressure vessel at this junction. The crimping of the end 54 takes place after the cylindrical portion is positioned on the cylindrical extension 46 and does affect the compression of the O-ring 48.

The crimped portion 54 and pulley 14 move in unison whenever the pulley half 14 is deflected due to the forces between the belt 16 and the pulley half 14 during operation. Since the crimped portion and pulley half 14 deflect in unison, the sealing joint 30 is unaffected by this motion, thereby retaining the excellent sealing qualities of the O-ring against the surface 36.

1. A pressure vessel and seal structure for a variable sheave comprising:
a sheave half having a first radial wall, a second radial wall, an annular space between said first and second radial walls, a cylindrical portion extending from said second radial wall, and an annular groove formed in said cylindrical portion;
an annular seal member disposed in said annular groove;
a housing having a tubular portion overlapping and extending axially from said cylindrical portion, and a radial wall portion cooperating with said sheave half and said tubular portion to form a fluid chamber, said tubular portion having a crimped end displaced into said annular space and an inner cylindrical wall portion cooperating with an outer cylindrical surface formed on said cylindrical wall portion and with said annular seal to provide a leakage containment structure between said sheave half and said housing.

2. A pressure vessel and seal structure for a variable sheave comprising:
a sheave half having a drive face, an annular seal groove and an annular recess formed between said drive face and said seal groove;
an annular seal member disposed in said seal groove; and
a cylindrical housing having a tubular portion and a radial portion, said tubular portion overlapping said seal and cooperating therewith to form a seal joint, said tubular portion being displaced into said annular recess to form a mechanical joint in cooperation with said sheave half independent of said seal joint.

3. The pressure vessel and seal structure for a variable sheave defined in claim 2 further wherein:
said sheave is subjected to deflection forces during operation and said mechanical joint compensates for said deflection forces whereby the seal joint is unaffected by said deflection forces.

4. The pressure vessel and seal structure for a variable sheave defined in claim 2 further wherein:
said seal joint is unaffected by the forming of the mechanical joint.
